(19) United States
(12) Patent Application Publication
(10) Pub. No.: US 2006/0075498 A1
(43) Pub. Date: Apr. 6, 2006

(54) Differential intrusion detection in networks

(76) Inventor: Eung-Moon Yeom, Suwon-si (KR)

Correspondence Address: Robert E. Bushnell, Suite 300, 1522 K Street, N.W., Washington, DC, 20005, US

(21) Appl. No.: 11/244,111

(22) Filed: Oct. 6, 2005

(30) Foreign Application Priority Data
Oct. 6, 2004 (KR) 2004-0079698

(51) Int. Cl. G06F 12/14

(52) U.S. Cl. 726/23

(57) ABSTRACT

Automatic differential intrusion detection in a network using an Intrusion Detection System (IDS) as a security device is provided, in order to enhance Quality of Service (QoS) for a packet requiring real-time processing. A delay caused by the IDS is reduced by applying differential IDS pattern matching according to the type of packet, thus reducing the time needed to process the packet.

### CLAIM OF PRIORITY

This application makes reference to, incorporates the same herein, and claims all benefits accruing under 35 U.S.C. § 119 from an application for APPARATUS AND METHOD FOR INTRUSION DETECTION IN NETWORK earlier filed in the Korean Intellectual Property Office on 6 Oct. 2004 and there duly assigned Serial No. 2004-0079698.

### BACKGROUND OF THE INVENTION

1. Field of the Invention

The present invention relates to an Intrusion Detection System (IDS) for network security and, more particularly, to applying differential intrusion detection to received packets.

2. Description of the Related Art

Data and communication security have recently become important in networks. An intrusion detection system is one apparatus used for network security. The intrusion detection system is a monitoring system that is operable to sense attacks and, if possible, track the attacks. The intrusion detection system inspects and monitors networks or systems, and takes necessary measures. For example, when an intrusion blocking system (i.e., firewall) is a locked door, the intrusion detection system can be considered to be a sensing device installed in a room to detect motion in the room. The intrusion detection system includes several schemes from checking a specific type of attack to discovering abnormal traffic.

A network including an intrusion detection system and an intrusion blocking system for security includes an intrusion detection system, an intrusion blocking system, and a switching device.

The intrusion detection system determines whether a received packet is an attack packet through packet matching in which various attack patterns are stored and the received packet is compared with the stored attack patterns. The intrusion blocking system functions to open or close a port for network connection according to a predefined policy. In the network using the intrusion detection system, the intrusion blocking system can control port connection and blockage under control of the intrusion detection system.

The switching device performs a switching function of transmitting respective packets to a requested site based on information contained in the received packet.

The intrusion detection system, the intrusion blocking system, and the switching device can be integrated

A network including an integrated switching device in which a security device and a switching device are integrated includes an integrated switching device (SME system) having a security function of performing pattern matching on a received packet and blocking the relevant packet when the relevant packet is an attack packet rather than a normal packet, and a switching function of performing switching on a normal packet. An intrusion detector, an intrusion blocker, and a switch are functional modules included in the integrated switching device for enabling the integrated switching device to perform the above-described security and switching functions. That is, the intrusion detector determines whether a relevant packet is an attack packet through packet matching in which various attack patterns are stored and the received packet is compared with the stored attack patterns. The intrusion blocker opens or closes a port for network connection according to a predefined policy. The switch performs a switching function of transmitting respective packets to a requested site based on information included in the received packets.

Meanwhile, in the network, transmission of packets requiring real-time processing such as a voice over Internet protocol (VoIP) is also performed. Transmission delay should be short for the packets requiring the real-time processing. However, since the intrusion detection system or the intrusion detector detects the intrusion by comparing an incoming packet with a number of pre-stored patterns using pattern/byte matching technology for intrusion detection packets, it causes the transmission delay. Accordingly, the packet requiring real-time processing such as a VoIP packet can experience degradation in Quality of Service (QoS) due to the transmission delay caused by the intrusion detection system or the intrusion detector. Furthermore, performance of the system is degraded due to a system load, which is increased by the pattern matching at the intrusion detection system or the intrusion detector.

That is, there is no method to cope with performance degradation caused by the pattern matching collectively performed on all packets to detect the intrusion.

### SUMMARY OF THE INVENTION

It is, therefore, an object of the present invention to provide an apparatus and method for differential intrusion detection which determines whether to perform intrusion detection on received packets.

It is another object of the present invention to provide an apparatus and method for differential intrusion detection allowing real-time processing of packets with an increased packet processing speed.

It is yet another object of the present invention to provide an apparatus and method for differential intrusion detection which determines whether to perform intrusion detection on packets that do not use well known ports.

In one aspect of the present invention, an apparatus for differential intrusion detection in a network including an Intrusion Detection System (IDS) is provided, the apparatus including: an intrusion detection system adapted to perform pattern matching on a received packet to detect intrusion, to determine whether to perform pattern matching based on a received control signal; and a switching device adapted to determine whether the received packet is a packet requiring pattern matching, and to generate the first control signal to the intrusion detection system based on the determination result, the first control signal containing information as to whether pattern matching is to be performed on the received packet.

In another aspect of the present invention, a method for automatic differential intrusion detection in a network comprising an intrusion detection system is provided, the method comprising: receiving a packet; determining whether the received packet requires real-time processing; and not performing pattern matching for intrusion detection on the packet requiring real-time processing, and performing pattern matching for intrusion detection on a packet requiring no real-time processing.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of a network including a security device, such as an IDS, and an intrusion blocking system (i.e., firewall), and a switching device, such as a keyphone or private branch exchange with a VoIP function;

FIG. 2 is a view of a configuration of a network including an integrated switching device in which a security device and a switching device are integrated;

FIG. 3 is a view of a configuration of an intrusion detector and a switch which are functional blocks of the integrated switching device of FIG. 2;

FIG. 4 is a view of a configuration of the intrusion detection system and the switching device of FIG. 1;

FIG. 5 is a view of a signal flow according to the present invention; and

FIG. 6 is a flowchart of sequential processes according to a method of an embodiment of the present invention.

### DETAILED DESCRIPTION OF THE INVENTION

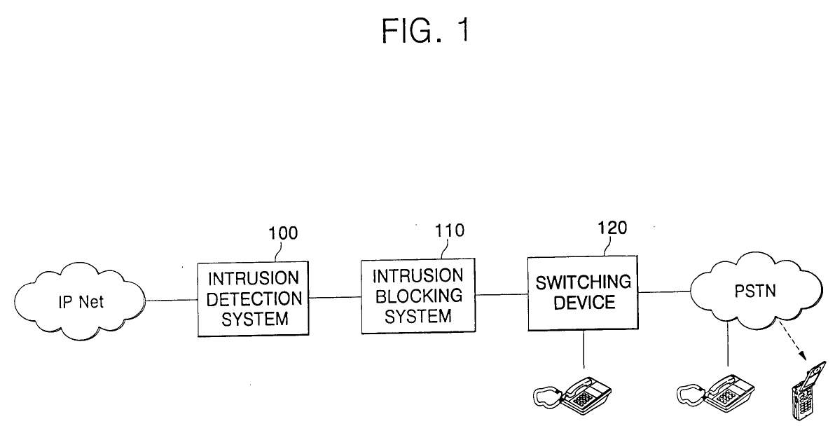

FIG. 1 is a view of a network including a security device, such as an IDS, and an intrusion blocking system (i.e., firewall), and a switching device, such as a keyphone or private branch exchange with a VoIP function.

As shown in FIG. 1, the network includes an intrusion detection system 100, an intrusion blocking system 110, and a switching device 120.

The intrusion detection system 100 determines whether a relevant packet is an attack packet through packet matching in which various attack patterns are stored and the received packets compared with the stored attack patterns. The intrusion blocking system 110 functions to open or close a port for network connection according to a predefined policy. In the network using the intrusion detection system 100 as shown in FIG. 1, the intrusion blocking system 110 can control port connection and blockage under control of the intrusion detection system 100.

The switching device 120 performs a switching function of transmitting respective packets to a requested site based on information contained in the received packets.

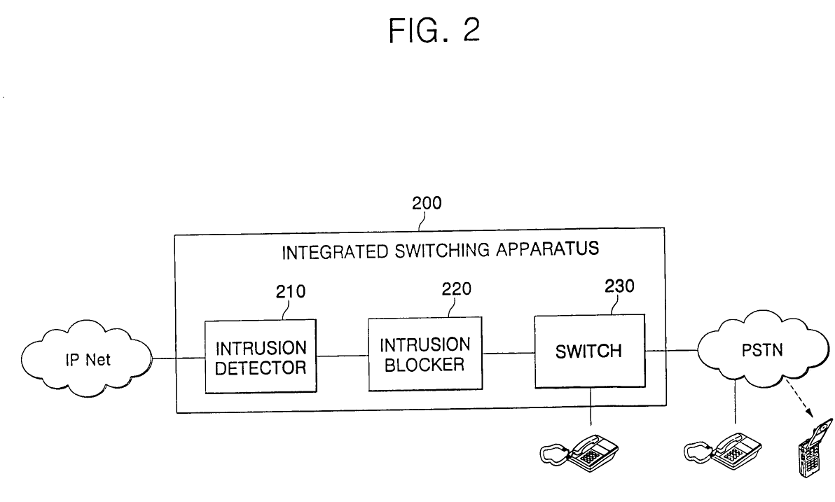

The intrusion detection system, the intrusion blocking system, and the switching device can be integrated as shown in FIG. 2.

FIG. 2 is a view of a network including an integrated switching device in which a security device and a switching device are integrated.

In FIG. 2, an integrated switching device (SME system) 200 has a security function of performing pattern matching on a received packet and blocking the relevant packet when the relevant packet is an attack packet rather than a normal packet, and a switching function of performing switching on a normal packet. In FIG. 2, an intrusion detector 210, an intrusion blocker 220, and a switch 230 are functional modules included in the integrated switching device 200 to enable the integrated switching device 200 to perform the above-described security and switching functions. That is, the intrusion detector 210 determines whether a relevant packet is an attack packet through packet matching in which various attack patterns are stored and the received packets compared with the stored attack patterns. The intrusion blocker 220 opens or closes a port for network connection according to a predefined policy. The switch 230 performs a switching function of transmitting respective packets to a requested site based on information included in the received packets.

In the network, transmission of packets requiring real-time processing, such as a Voice 8 over Internet Protocol (VoIP), is also performed. Transmission delay should be short for the packets requiring the real-time processing. However, since the intrusion detection system 100 or the intrusion detector 210 detects the intrusion by comparing an incoming packet with a number of pre-stored patterns using pattern/byte matching technology for intrusion detection packets, it causes the transmission delay. Accordingly, the packet requiring real-time processing, such as a VoIP packet, can experience degradation in Quality of Service (QoS) due to the transmission delay caused by the intrusion detection system 100 or the intrusion detector 210. Furthermore, performance of the system is degraded due to a system load, which is increased by the pattern matching at the intrusion detection system 100 or the intrusion detector 210.

The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and will fully convey the scope of the present invention to those skilled in the art. Like numbers refer to like elements throughout the specification.

The present invention described below can be implemented using IP and port information. That is, when it is determined that packets requiring real-time processing begin to be received via a specific port, the present invention blocks an intrusion detection function on subsequent packets received via the port. The present invention then releases the blockage of the intrusion detection function with respect to the packets received via the port when it has been determined that receipt of the packets requiring real-time processing via the port has been terminated.

Determining whether the received packet is a packet requiring the real-time processing is effected by a switching device. When it has been determined that a packet requiring the real-time processing has been received, the switching device transmits, to the intrusion detection system, a number (No.) of a port via which the packet has been received and a signal indicating whether the intrusion detection function has been blocked. When receiving the signal from the switching device, the intrusion detection system can determine whether to perform the pattern matching on the packet received via the port indicated by the signal, based on the signal. When it has been determined that the receipt of real-time processing packet via the port has been completed, the switching device transmits, to the intrusion detection system, the port information and the signal indicating whether the intrusion detection function has been blocked.

As described above, the present invention determines whether to block the intrusion detection function on a call basis, i.e., on a unit from initiation of one call to termination thereof. The switching device determines whether the received packet is a packet requiring real-time processing through the intrusion detection system, and thus initial packets of all calls in the present invention are packets on which determining whether the packet is an attack packet is effected by packet matching for intrusion detection.

The embodiments of the present invention will be described in detail with reference to the accompanying drawings. The present invention described below will be described in conjunction with embodiments employing IP packets. Furthermore, in the embodiments described below, an exemplary packet requiring real-time processing is a VoIP packet. However, this is only intended to assist in understanding the present invention rather than to limit the present invention.

The present invention is applicable to a network including the integrated switching device 200 of FIG. 2, or to a network including the intrusion detector 210, the intrusion blocker 220, and the switch 230 as independent modules of FIG. 1. A first embodiment which is applicable to the network including the integrated switching device of FIG. 2 is described below.

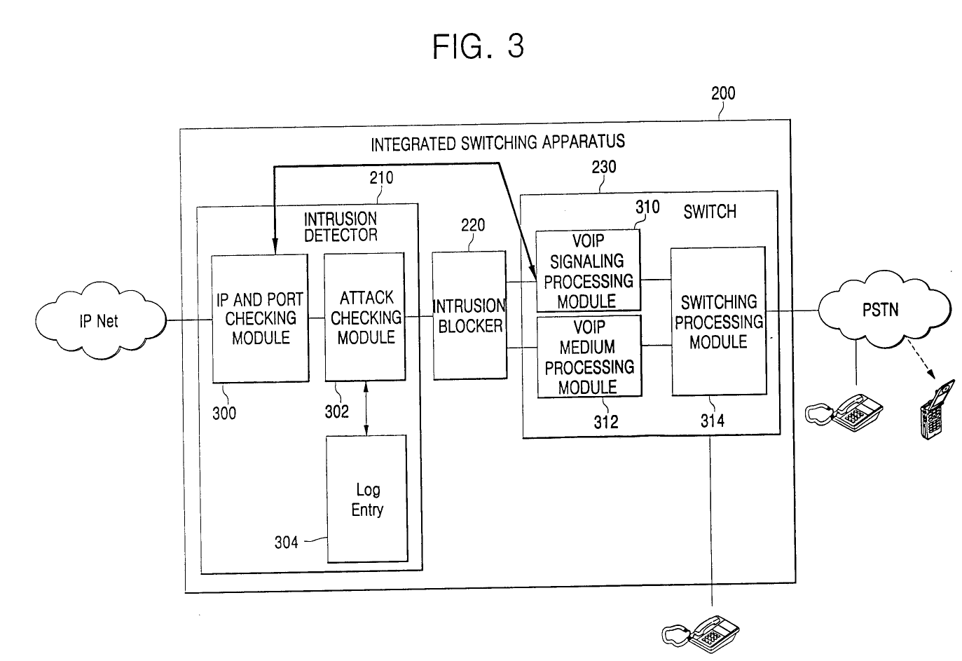

FIG. 3 is a view of an intrusion detector and a switch that are functional blocks of the integrated switching device of FIG. 2.

In FIG. 3, the intrusion detector 210 determines whether a received packet is an attack packet through packet matching in which various attack patterns are stored and the received packets compared with the stored attack patterns. The intrusion detector 210 can include an IP and port checking module 300, an attack checking module 302, and a log entry module 304.

The IP and port checking module 300 is specially used in the present invention. The IP and port checking module 300 is a module that interfaces with the switch 230 and compares dynamic IP and port information provided from the switch 230 with the received IP packet to determine whether to apply the intrusion detection function, i.e., effects pattern matching to the received IP packet. The IP and port checking module 300 generates a control signal indicating whether the pattern matching should be applied to the received packet based on the information provided from the switch 230 and provides the control signal to the attack checking module 302, so that the attack checking module 302 does not perform pattern matching on the received packet.

The attack checking module 302 checks whether the received IP packet is a normal packet, using pattern/byte matching (hereinafter, referred to as pattern matching) technology when receiving the IP packet via a network (e.g., IP network). Pattern matching is a process of comparing the received packet with IP pattern/byte information stored in the log entry module 304 to determine whether there is a pattern matching the received packet. The attack checking module 302 determines that the received packet is an attack packet rather than the normal packet when it has been determined in the pattern matching process that there is a pattern matching the received packet. In the present invention, the attack checking module 302 receives the control signal from the IP and port checking module 300 and determine whether to perform the pattern matching on the received packet in response to the control signal.

The log entry module 304 is a database that stores the IP pattern/byte information for intrusion detection.

In FIG. 3, the intrusion blocker 220 opens or closes a port for network connection according to a predefined policy. The intrusion blocker 220 can also block packets under control of the intrusion detector 210.

The switch 230 transmits respective received packets to a requested destination, based on the information contained in the received packets. The switch 230 further generates and outputs a signal indicating the type of received packet. The switch 230 can include a VoIP signaling processing module 310, a VoIP medium processing module 312, and a switching (K/P Legacy local/extension) processing module 314.

The VoIP signaling processing module 310 performs signaling for a VoIP call. The VoIP signaling processing module 310 determines the type of received packet based on header information in the received packet. The VoIP medium processing module 312 is responsible for medium transcoding for the VoIP call. The switching processing module 314 performs a switching function on the respective packets.

In particular, when it has been determined that the received packet is a VoIP packet requiring real-time processing, the switch 230 generates a signal indicating that fact to the IP and port checking module 300 in the intrusion detector 210, so that the intrusion detector 210 applies a differential IDS to the received packet according to the type of packet. One call is generally received via the same port from the initiation of the call to the termination thereof. That is, it can be considered that the port receiving VoIP packets receives VoIP packets until the call containing the packets has been terminated. Accordingly, when receiving VoIP packets, the switch 230 provides the IP and port information of the relevant VoIP packets to the intrusion detector 210, so that the intrusion detector 210 applies the differential IDS to the VoIP packets and does not perform the pattern matching on the VoIP packets received via the relevant port. Furthermore, when a call determined to be a VoIP call has been terminated, the switch 230 provides a signal indicating the termination to the intrusion detector 210, so that the intrusion detector 210 terminates the blockage of pattern matching on the packets received via the relevant port and performs pattern matching on subsequent packets received via the port. That is, the switch 230 generates a signal indicating the start and end of the pattern-matching blockage for packets received via any port and provides the signal to the intrusion detector 210. The signal includes IP and port information on the port which received the VoIP packets and information indicating whether pattern matching has been blocked.

Specifically, the VoIP signaling processing module 310 of the switch 230 generates a signal provided to the IP and port checking module 300 in the intrusion detector 210. The VoIP signaling processing module 310 checks information on the VoIP IP and port. That is, the VoIP signaling processing module 310 checks whether the received packet is a VoIP packet requiring real-time processing and, when the received packet is a VoIP packet, generates a signal containing IP and port information of the received packet and information to block pattern matching for the packet received via the relevant port, and provides the signal to the IP and port checking module 300 in the intrusion detector 210. When receiving the last packet for the call via the port, the VoIP signaling processing module 310 then generates a signal containing relevant IP and port information and information indicating the termination of pattern matching blockage for the packet received via the relevant packet, and provides the signal to the IP and port checking module 300.

In this embodiment, since the intrusion detector 210 and the switch 230 are parts constituting the integrated switching device 200, the switch 230 is able to provide the signal to the intrusion detector 210 to block pattern matching for the VoIP packet, using Inter-Processor Communication (IPC).

A second embodiment will be now described in which a differential IDS is applied to a network in which the intrusion detection system and the switching device exist as non-integrated, i.e., independent modules.

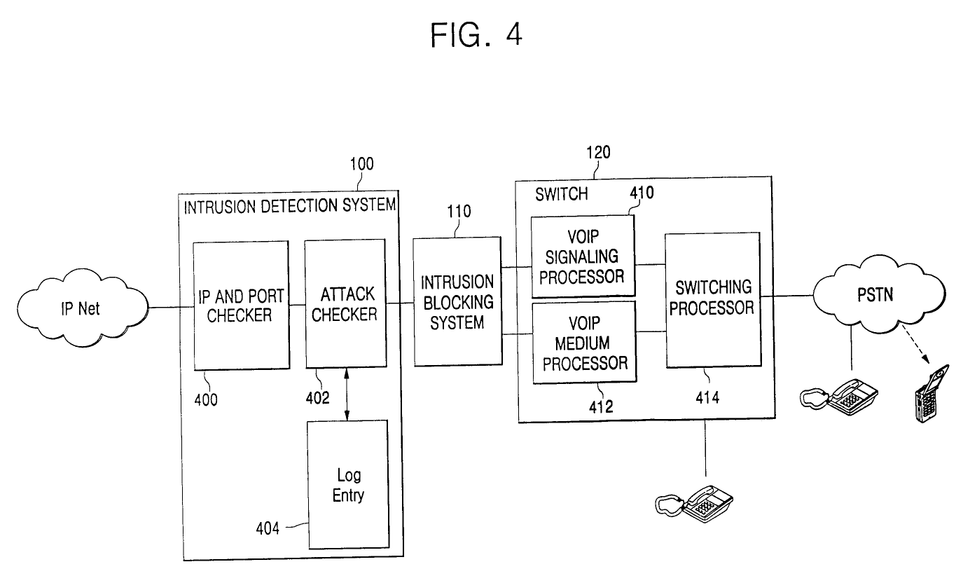

FIG. 4 is a view of the intrusion detection system and switching device of FIG. 1.

In FIG. 4, an intrusion detection system 100 performs intrusion detection to determine whether a received packet is an attack packet through packet matching in which various attack patterns are stored and the received packet is compared with the stored attack patterns. The intrusion detection system 100 includes an IP and port checker 400, an attack checking module 402, and a pattern storage 404.

The IP and port checker 400 determines whether to perform pattern matching on the received packet, based on dynamic IP and port information provided by the switching device 120. The IP and port checker 400 also generates and outputs a control signal indicating whether pattern matching should be applied to the received packet, based on the information provided by the switching device 120.

The attack checker 402 performs pattern matching to determine whether the received IP packet is an intrusion detection packet. The attack checker 402 determines whether to perform pattern matching on the received packet, based on the control signal received from the IP and port checker 400.

The attack pattern storage 404 stores IP pattern information for intrusion detection.

The intrusion detection system 110 opens or closes a port for network connection according to a predefined policy.

The switching device 120 performs a switching function on the relevant packets, based on the information contained in the received packets, and generates a signal indicating the type of received packets and transmits the generated signal to the intrusion detection system 100. The switching device 120 includes a VoIP signaling processor 410, a VoIP medium processor 412, and a switching processor 414.

The VoIP signaling processor 410 performs signaling for a VoIP call. The VoIP signaling processor 410 determines the type of received packets based on header information of the received packets. The VoIP medium processor 412 is responsible for medium-transcoding for the VoIP call. The switching processor 414 performs a switching function for the respective packets.

When it has been determined that the received packet is a VoIP packet requiring real-time processing, the switching device 120 generates a signal indicating that fact and provides the generated signal to the IP and port checking module 300 of the intrusion detector 210, so that the intrusion detection system 100 applies a differential IDS to the packets according to the type of packet. According to the present invention, the differential intrusion detection can be achieved using the port information since one call is generally received via the same port from the initiation of the call to the termination thereof.

When receiving the VoIP packet, the switching device 120 transmits a signal to the intrusion detection system 100, the signal containing the IP and port information for the VoIP packet and an indication to block pattern matching on packets received via the relevant port. When the VoIP call for which the pattern matching has been blocked has been terminated, the switching device 120 transmits a signal to the intrusion detection system 100, the signal containing the IP and port information for the packet and an indication to terminate the pattern matching blockage for the packet received via the relevant port.

The VoIP signaling processor 410 of the switching device 120, which is capable of checking the IP and port information of the received packet or the like, generates the signal and transmits the generated signal to the IP and port checker 400 of the intrusion detection system 100. That is, the VoIP signaling processor 410 checks whether the received packet is the VoIP packet requiring real-time processing. When it has been determined that the relevant packet is a VoIP packet, the VoIP signaling processor 410 generates a signal containing the IP and port information of the received packet and information to block pattern matching for the packet received via the relevant port, and transmits the generated signal to the IP and port checker 400 of the intrusion detection system 100. When receiving the last packet of the call via the packet, the VoIP signaling processor 410 then generates a signal containing the relevant IP and port information and information to terminate blocking pattern matching for the packet received via the relevant packet, and transmits the signal to the IP and port checker 400.

In the second embodiment as described above, signal transmission between the switching device 120 and the intrusion detection system 100 cannot be made using the IPC since the intrusion detection system 100 and the switching device 120 exist as independent modules, unlike the first embodiment. Accordingly, in the second embodiment, a signal that the switching device 120 transmits to the intrusion detection system 100 should contain the IP and port information of the relevant packet and information indicating whether pattern matching has been blocked, as well as information indicating that the destination of the signal is the intrusion detection system 100.

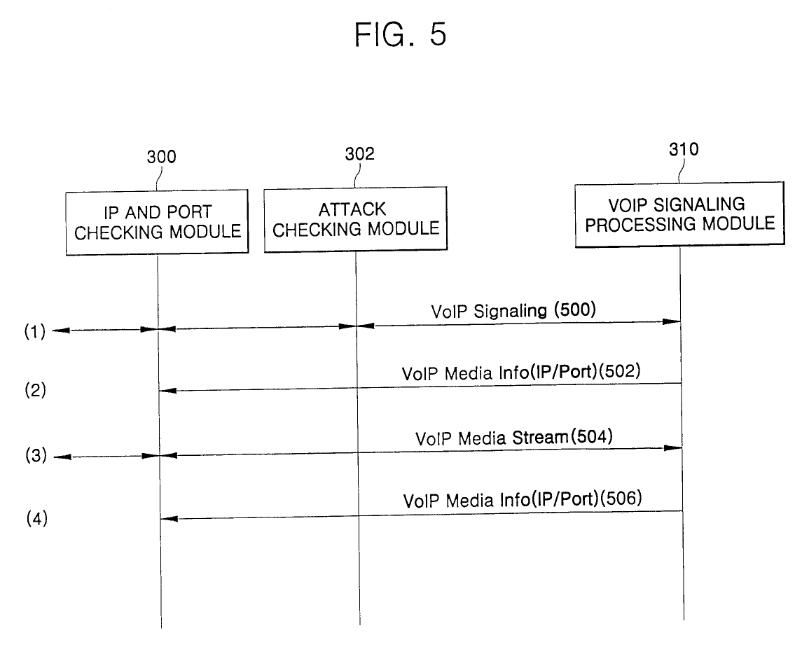

FIG. 5 is a view of a signal exchange between the intrusion detector and the switch in the network of FIG. 3.

FIG. 5 only shows a signal flow between the IP and port checking module 300, the attack checking module 302, and the VoIP signaling processing module 310 related directly to the present invention.

In FIG. 5, (1) refers to a VoIP signaling process for a VoIP call. A VoIP signaling signal 500 can be used herein. The VoIP signaling processing module 310 performs the VoIP signaling process with a correspondent of a relevant VoIP call via the attack checking module 302, the IP and port checking module 300, and the network (e.g., IP network). The VoIP signaling signal 500 can be used for this processing. The VoIP signaling processing module 310 initiates initial signaling using a well-known port (e.g., H.323 TCP 1719, 1720 port, or SIP UDP 5060 port). The VoIP signaling processing module 310 obtains IP and port information of a relevant packet through the VoIP signaling process indicated by (1). When checking the IP/port, the intrusion detector 210 frequently checks intrusion via generally well known ports. Thus, it is possible to select whether to perform intrusion detection.

(2) refers to a process of indicating whether pattern matching should be blocked for the relevant packet. The VoIP signaling processing module 310 determines whether the relevant packet is a packet requiring real-time processing, i.e., a packet requiring pattern matching to be blocked, and generates a VoIP medium information signal (VoIP Media Info (IP/Port) 502 and transmits the generated signal to the IP and port checking module 300 to indicate whether pattern matching should be blocked. The VoIP medium information signal 502 includes a signal indicating whether pattern matching should be performed, and the IP and port information of the relevant packet obtained through the VoIP signaling process in (1).

(3) refers to a process of transferring a packet for which pattern matching has been blocked. The packet (VoIP Media Stream) 504 for which pattern matching has been blocked is transmitted to the VoIP signaling processing module 310 without performing pattern matching in the attack checking module 302.

(4) refers to a process indicating the termination of pattern matching blockage for a call for which pattern matching has been blocked. When receiving the last packet of the VoIP call, the VoIP signaling processor 310 transmits a VoIP medium information signal (VoIP Media Info(IP/Port)) 506 to the IP and port checking module 300, the signal containing IP and port information of the relevant packet and information to terminate packet matching blockage for the relevant packet.

The VoIP medium information signals 502 and 506 in (2) and (3) can be transferred through IPC.

By performing differential intrusion detection according to dynamically varying VoIP IP and port information through such processes, it is possible to improve voice quality of the VoIP and reduce system load, thus improving the performance of the system.

The signal exchange between the IP and port processor 400, the attack checker 402 and the VoIP signaling processor 410 of FIG. 4 is also similar to the signal flow of FIG. 5. However, IPC is unavailable between the IP and port processor 400 and the VoIP signaling processor 410. Accordingly, when generating the VoIP medium information signal, the VoIP signaling processor 410 includes, in the VoIP medium information signal, information indicating that the IP and port checking module 400 is a destination of the relevant signal, in addition to the signal containing the IP and port information and the information indicating whether pattern matching should be blocked.

The method for differential intrusion detection according to the present invention will be described with reference to the accompanying drawings.

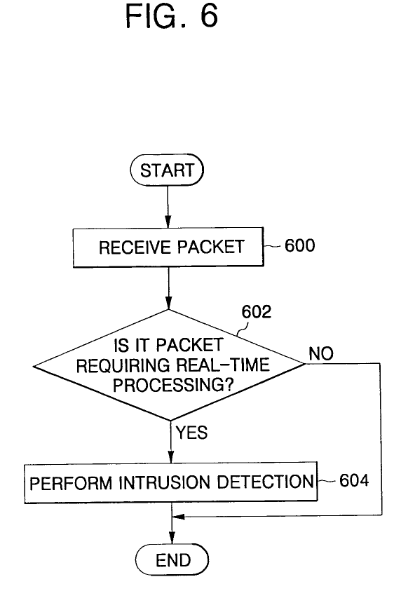

FIG. 6 is a flowchart of sequential processes according to a method of an embodiment of the present invention.

In FIG. 6, an apparatus for differential intrusion detection according to an embodiment of the present invention receives a packet from a network, in Step 600. In Step 602, the apparatus determines whether the received packet is a packet requiring real-time processing. When it has been determined in Step 602 that the received packet is a packet requiring real-time processing, i.e., a packet requiring pattern matching, the apparatus performs pattern matching on the received packet in Step 604. On the other hand, when it has been determined in Step 602 that the received packet is not a packet requiring real-time processing, i.e., the packet does not require pattern matching, the apparatus does not perform pattern matching on the received packet.

The present invention has differentiated the received packet into packets requiring the real-time processing and packets not requiring real-time processing to determine whether to perform pattern matching for intrusion detection. However, the present invention can determine whether to perform pattern matching based on other differentiating criteria. That is, the present invention is applicable to all cases where it is allowed to differentiate the received packets into packets requiring pattern matching and packets not requiring pattern matching.

The present invention is capable of increasing the packet processing speed by determining whether to apply pattern matching for intrusion detection to packets according to features of the packets and performing differential intrusion detection based on the determination result in the network including the intrusion detection system. Accordingly, the present invention is capable of improving the QoS of the system.

According to the present invention, it is possible to increase the processing speed for packets requiring the real-time processing, such as VoIP packets.

The present invention can be effectively used for packets that do not use well known ports in data applications. The present invention can perform differential intrusion detection on dynamically varying IPs and ports.

What is claimed is:

1. An apparatus comprising:
an intrusion detection system adapted to perform pattern matching on a received packet to detect intrusion, and to determine whether to perform pattern matching based on a received first control signal; and
a switching device adapted to determine whether the received packet is a packet requiring pattern matching, and to generate and transmit the first control signal to the intrusion detection system based on the determination result, the first control signal including information indicating whether pattern matching is to be performed on the received packet.

2. The apparatus according to claim 1, wherein the first control signal includes Internet Protocol (IP) information and port information of the received packet and information indicating whether the pattern matching is to be performed on the received packet.

3. An apparatus comprising:
an intrusion detection system adapted to perform pattern matching on a received packet to detect intrusion, and to determine whether to perform pattern matching based on a received first control signal; and
a switching device adapted to determine whether the received packet is a packet requiring real-time processing, and to generate and transmit the first control signal to the intrusion detection system based on the determination result, the first control signal including information indicating whether pattern matching is to be performed on the received packet.

4. The apparatus according to claim 3, wherein the packet requiring real-time processing is a Voice over Internet Protocol (VoIP) packet.

5. The apparatus according to claim 3, wherein the first control signal includes Internet Protocol (IP) information and port information of the received packet and information indicating whether pattern matching is to be performed on a packet received via a relevant port.

6. The apparatus according to claim 3, wherein the switching device is adapted to output the first control signal to the intrusion detection system in response to a determination that the received packet is a packet requiring the real-time processing, the first control signal including Internet Protocol (IP) information and port information of the received packet, and information to block pattern matching for the packet received via a relevant port.

7. The apparatus according to claim 6, wherein the switching device is adapted to output the first control signal to the intrusion detection system in response to a determination that receipt of the packet requiring real-time processing via the port for which pattern matching has been blocked has been terminated, the first control signal including the Internet Protocol (IP) information and the port information of the received packet, and information to perform pattern matching.

8. The apparatus according to claim 3, wherein the switching device comprises a Voice over Internet Protocol (VoIP) signaling processor adapted to check Internet Protocol (IP) and port information of a received VoIP packet and to generate and output the first control signal, the first control signal including the IP information and the port information and the information indicating whether pattern matching is to be blocked.

9. An apparatus comprising:
an intrusion detector adapted to perform pattern matching on a received packet to detect intrusion; and
a switch adapted to determine whether the received packet is a packet requiring real-time processing and, upon a determination that the received packet requires real-time processing, to transmit a control signal to the intrusion detector via Inter-Processor Communication (IPC), the control signal including information to block pattern matching on the received packet.

10. An apparatus comprising:
an intrusion detection system adapted to perform pattern matching on a received packet to detect intrusion, and to determine whether to perform pattern matching based on a received control signal; and
a switching device adapted to determine whether the received packet is a first packet of a call and, upon a determination that the received packet is the first packet of a call, to transmit the control signal to the intrusion detection system, the control signal including information indicates whether pattern matching is to be performed on the received packet.

11. The apparatus according to claim 10, wherein the control signal includes at least Internet Protocol (IP) information and port information of the received packet and information indicating whether to pattern matching is to be performed on the received packet.

12. The apparatus according to claim 11, wherein the control signal further includes information indicating that the intrusion detection system is a destination.

13. A method comprising:
receiving a packet;
determining whether the received packet is a packet requiring perform pattern matching; and
performing packet matching on the packet requiring pattern matching and not performing packet matching on a packet not requiring pattern matching, based on the determination result.

14. The method according to claim 13, wherein determining whether the received packet requires pattern matching is based on Internet Protocol (IP) information and port information included in the packet.

15. The method according to claim 13, wherein determining whether the received packet requires pattern matching is effected by determining a packet received via a port for which pattern matching has been blocked as a packet not requiring pattern matching and a packet received via a port for which pattern matching has not been blocked as a packet requiring pattern matching.

16. The method according to claim 15, wherein, upon a determination that receipt of a packet not requiring pattern matching via the port being terminated, subsequent packets received via the port being determined to be packets requiring pattern matching.

17. A method comprising:
receiving a packet;
determining whether the received packet is a packet requiring real-time processing; and
not performing pattern matching on packet requiring the real-time processing, and performing pattern matching on a packet not requiring the real-time processing, based on the determination result.

18. The method according to claim 17, wherein the packet requiring real-time processing is a Voice over Internet Protocol (VoIP) packet.
